(19) United States
(12) Patent Application Publication
(10) Pub. No.: US 2006/0110257 A1
(43) Pub. Date: May 25, 2006

(54) Ceiling fan blade

(76) Inventor: Yu-Keng Huang, Tucheng City (TW)

Correspondence Address: Yu-Keng Huang, P. O. Box No. 6-57, Junghe, Taipei, 235, TW

(21) Appl. No.: 10/994,350

(22) Filed: Nov. 23, 2004

(51) Int. Cl. B64C 11/16

(52) U.S. Cl. 416/235

(57) ABSTRACT

The present invention relates to an improvement of a ceiling fan blade, with dimples distributing thereon. When blades rotating, air flowing dimples will generate turbulence that disturbs air deflection angles, causing an increase in wind speed and a decrease in noise level. Therefore, the present invention is new, advanced and practical in application.

### BACKGROUND OF THE INVENTION

a) Field of the Invention

The present invention relates to an improvement of a ceiling fan blade, especially for a blade structure which not only increases fan speed but also reduces noise.

(b) Description of the Prior Art

A conventional ceiling fan blade is of a flat surface connecting to a motor assembly with an angle of about 15°. As the flat blade surface sweeping across air, angle of air flow flowing to the surface will be the same as that of deflecting from the surface, wind thereby generated will be equally distributed and weakened. With the friction resistance, a higher noise level generates when blades rotating.

### SUMMARY OF THE INVENTION

The present invention relates to an application of hydrodynamics theory to improve a ceiling fan blade structure, which is similar to that for a golf ball. According to a study, a golf ball with dimpled surface will generate turbulence, enabling the ball flying two and a half farther than that with a smooth surface. Therefore, with dimples distributed on one side of a blade surface, turbulence will be generating when rotating blades, which disturb air deflection angles. As a result, an increase of wind and a decrease of noise can be expected. Therefore, the present invention is new, advanced and practical in application.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a perspective view of the present invention.

FIG. 2 shows a local enlarged view.

FIG. 3 shows another perspective view of the present invention.

### DETAILED DESCRIPTION OF THE PREFERRED EMBODIMENTS

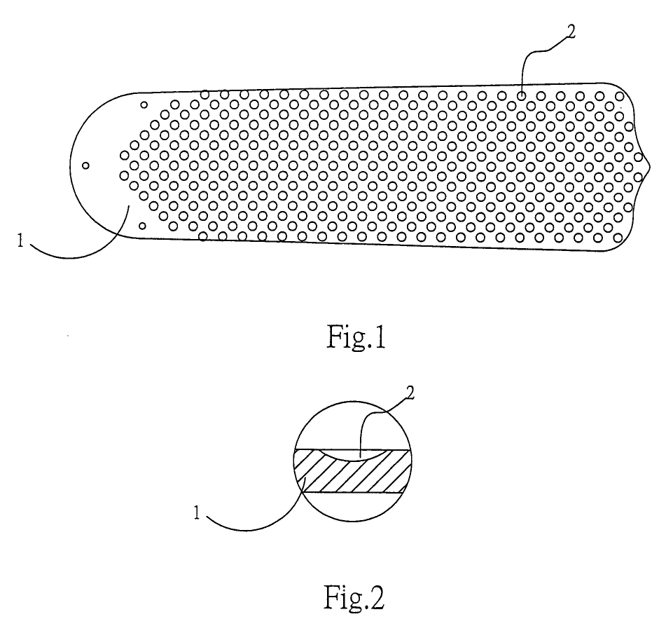

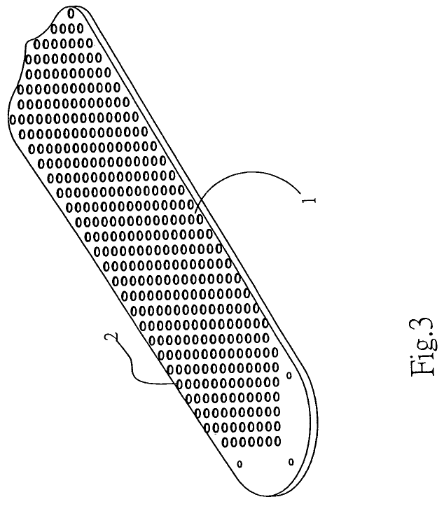

Referring to FIGS. 1˜3. The present invention relates to an improvement of a ceiling fan blade 1, with dimples 2 distributing thereon. When blades 1 rotating, dimples 2 will cause turbulence, which disturbs air deflection angles, causing an increase in wind speed and also a decrease in noise level.

Dimples 2 can also be formed on both sides of the blade 1.

In summary, with a study result that a golf ball with dimpled surface generates turbulence that enables the ball flying two and a half farther than that with a flat surface, a ceiling fan blade with dimples distributing on one side or two sides of a blade will generate turbulence, which disturbs air deflection angles when blades rotating. As a result, an increase of wind and a decrease of noise can be expected. Therefore, the present invention is new, advanced and practical in application.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A ceiling fan blade comprising dimples distributing on one or two surfaces thereof, which generates air turbulence when blades rotating.
